(19) United States
(12) Patent Application Publication
(10) Pub. No.: US 2025/0306255 A1
(43) Pub. Date: Oct. 2, 2025

(54) TUNABLE WAVELENGTH INTERFERENCE FILTER

(71) Applicant: SEIKO EPSON CORPORATION, TOKYO (JP)

(72) Inventors: Kengo TAKAGI, MATSUMOTO-SHI (JP); Kei KUDO, SHIOJIRI-SHI (JP)

(21) Appl. No.: 19/090,523

(22) Filed: Mar. 26, 2025

(30) Foreign Application Priority Data
Mar. 26, 2024 (JP) 2024-050214

(51) Int. Cl. G02B 5/28; G02B 5/00; G02B 26/00

(52) U.S. Cl. CPC G02B 5/285; G02B 26/007; G02B 5/005

(57) ABSTRACT

A tunable wavelength interference filter includes a first substrate, a first reflective film and a first conductive film formed in the first substrate, a second substrate facing the first substrate, a second reflective film provided at the second substrate and facing the first reflective film with a predetermined gap therebetween, a second conductive film provided at the second substrate and facing the first conductive film, and a stopper post provided as a part of the second substrate, and protruding toward the first substrate so as to be exposed from the second conductive film. The second conductive film includes a stopper film disposed overlapping a peripheral part of the second reflective film, and when the movable part is displaced toward the second substrate, a timing when the stopper post interferes with the first conductive film is later than a timing when the stopper film interferes with the first reflective film.

The present application is based on, and claims priority from JP Application Serial Number 2024-050214, filed Mar. 26, 2024, the disclosure of which is hereby incorporated by reference herein in its entirety.

### BACKGROUND

### 1. Technical Field

The present disclosure relates to a tunable wavelength interference filter.

### 2. Related Art

In the related art, tunable wavelength interference filters that transmit light of a predetermined wavelength among incident light are known (for example JP-A-2010-8644). Such a tunable wavelength interference filter includes a first substrate and a second electrode facing each other, a first reflective film and a first electrode provided at the first substrate, and a second reflective film and a second electrode provided at the second substrate. The first reflective film and the second reflective film are disposed facing each other to form a filter region that transmits light of a specific wavelength in accordance with the size of the gap therebetween. The first electrode and the second electrode are disposed facing each other to make up an actuator for changing that size of the gap.

In the above-described tunable wavelength interference filter, the contact between the first reflective film and the second reflective film or the contact between the first electrode and the second electrode is undesirable because it impairs the function of the tunable wavelength interference filter. In view of this, the tunable wavelength interference filter disclosed in JP-A-2010-8644 includes a protrusion at the first substrate or the second substrate for preventing the contact between the first reflective film and the second reflective film or the contact between the first electrode and the second electrode.

In JP-A-2010-8644, however, the step of forming the protrusion is performed separately after the step of forming the reflective film and the electrode, and as such the manufacturing method for the tunable wavelength interference filter is complicated.

In addition, in JP-A-2010-8644, when changing the size of the gap between the first reflective film and the second reflective film, the protrusion may unnecessarily interfere with the first substrate or second substrate, and as such the function of the tunable wavelength interference filter is not sufficiently ensured.

### SUMMARY

A tunable wavelength interference filter according to an aspect of the present disclosure includes a first substrate including a movable part and a diaphragm part configured to displaceably support the movable part, a first reflective film formed in the movable part of the first substrate, a first conductive film formed around the first reflective film in the first substrate, a second substrate facing the first substrate, a second reflective film provided at the second substrate and facing the first reflective film with a predetermined gap between the first reflective film and the second reflective film, a second conductive film provided at the second substrate and facing the first conductive film, and a stopper post provided as a part of the second substrate, and protruding toward the first substrate so as to be exposed from the second conductive film. At least one of the first conductive film and the second conductive film includes a stopper film disposed overlapping a peripheral part of the first reflective film or a peripheral part of the second reflective film, and in a case where the movable part is displaced toward the second substrate, a timing when the stopper post interferes with the first conductive film is later than a timing when the stopper film interferes with the first reflective film or the second reflective film.

### BRIEF DESCRIPTION OF THE DRAWINGS

FIG. 1 is a sectional view illustrating an outline of a configuration of a tunable wavelength interference filter according to an embodiment of the present disclosure.

FIG. 2 is a plan view illustrating an outline of a configuration of a second substrate making up the tunable wavelength interference filter according to the embodiment.

FIG. 3 is a diagram for describing an operation of the tunable wavelength interference filter according to the embodiment, and illustrating a first interference timing.

FIG. 4 is a diagram for describing an operation of the tunable wavelength interference filter according to the embodiment, and illustrating a second interference timing.

FIG. 5 is a graph illustrating the amount of displacement of a first substrate corresponding to the distance from the center portion of a first reflective film in the tunable wavelength interference filter according to the embodiment.

### DESCRIPTION OF EMBODIMENTS

A tunable wavelength interference filter 1 according to an embodiment is described below with reference to the accompanying drawings.

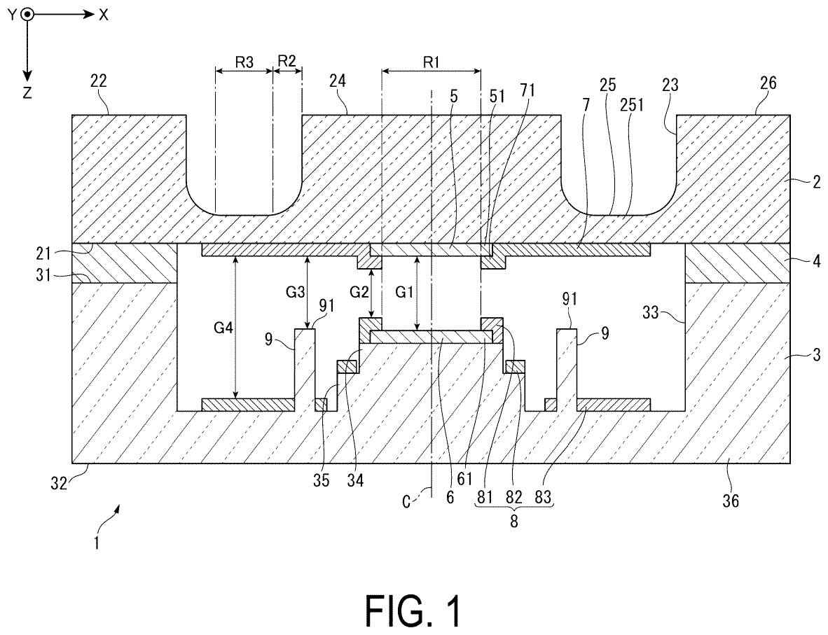

As illustrated in FIG. 1, the tunable wavelength interference filter 1 according to the embodiment includes a first substrate 2 and a second substrate 3 disposed facing each other, a joining part 4 that joins the first substrate 2 and the second substrate 3, a first reflective film 5 and a first conductive film 7 provided in the first substrate 2, a second reflective film 6 and a second conductive film 8 provided in the second substrate 3, and a stopper post 9 provided in the second substrate 3.

Note that in the tunable wavelength interference filter 1 according to the embodiment, the first reflective film 5 and the second reflective film 6 disposed facing each other form a filter region R1, and the wavelength of light passing through the filter region R1 is changed by changing a gap G1 between the first reflective film 5 and the second reflective film 6. This tunable wavelength interference filter 1 can be used as a spectral filter for spectral measurement devices that spectrally measure light from a measurement object.

### Configuration of Tunable Wavelength Interference Filter 1

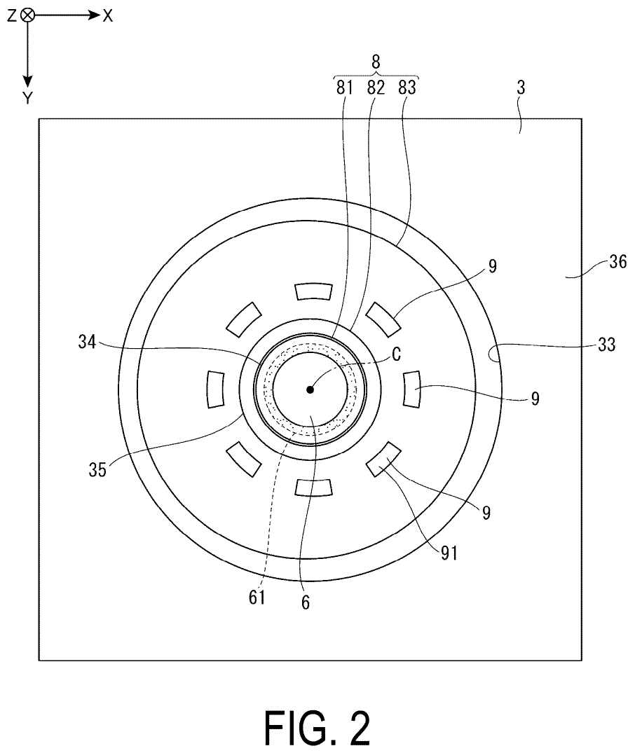

A configuration of the tunable wavelength interference filter 1 is described below with reference to FIGS. 1 and 2. In the following description, the direction from the first substrate 2 toward the second substrate 3 is the Z direction, the direction orthogonal to the Z direction is the X direction, and the direction orthogonal to the Z direction and the X direction is the Y direction. The Z direction corresponds to the thickness direction of the tunable wavelength interference filter 1.

Each of the first substrate 2 and the second substrate 3 is formed of a material that is optically transparent to given wavelength ranges, such as a silicon substrate or glass substrate. In addition, the first substrate 2 and the second substrate 3 are integrally configured as a structure with a cavity formed therebetween.

More specifically, the first substrate 2 includes a first surface 21 that faces the second substrate 3, and a second surface 22 located on the side opposite to the first surface 21. When the first substrate 2 is viewed from the Z direction, an annular groove 23 that surrounds the first reflective film 5 is formed in the second surface 22 of the first substrate 2. Thus, the first substrate 2 includes a movable part 24 where the first reflective film 5 is provided, a thin diaphragm part 25 disposed to surround the movable part 24, and a base part 26 that supports the movable part 24 through the diaphragm part 25.

The diaphragm part 25 supports the movable part 24 such that the movable part 24 is displaceable in the Z direction. In addition, with the shape of the groove 23 formed in the first substrate 2, the diaphragm part 25 includes a flat part 251 with a uniform thickness in the Z direction that is smaller than the movable part 24. In the following description, when the first substrate 2 is viewed from the Z direction, the region between the flat part 251 and the movable part 24 in the first substrate 2 is referred to as a diaphragm start region R2. This diaphragm start region R2 is an annular region around the center portion of the diaphragm part 25 in the first substrate 2.

Note that the specific shape of the annular the groove 23 in the first substrate 2 is not limited, but preferably the bottom portion of the groove 23 has an R shape on both sides in the radial direction with respect to the flat part 251.

The second substrate 3 includes a third surface 31 that faces the first substrate 2, and a fourth surface 32 located on the side opposite to the third surface 31. A recess 33 with a predetermined depth is formed in the third surface 31 of the second substrate 3, and the recess 33 forms a cavity between the first substrate 2 and the second substrate 3.

In addition, the second substrate 3 includes a first base 34 disposed in the center region in the recess 33, an annular second base 35 disposed to surround the first base 34, and a base part 36 disposed around the recess 33. The second reflective film 6 is provided at the top surface of the first base 34, a capacitance detection electrode 82 (described later) of the second conductive film 8 is provided at the top surface of the second base 35, and a drive electrode 83 (described later) of the second conductive film 8 is provided at the bottom surface of the recess 33.

The height of the first base 34 in the Z direction is set in accordance with the initial gap G1 between the first reflective film 5 and the second reflective film 6, and the height of the second base 35 in the Z direction is smaller than the height of the first base 34 in the Z direction. In other words, the top surface of the second base 35 is farther from the first substrate 2 compared to the top surface of the first base 34.

The joining part 4 is disposed between the base part 26 of the first substrate 2 and the base part 36 of the second substrate 3, and joins the first substrate 2 and the second substrate 3 to each other. Film materials known in the related art may be used for the film material of the joining part 4.

The first reflective film 5 is provided at the first surface 21 of the movable part 24 of the first substrate 2. In addition, in plan view as viewed from the Z direction, the first reflective film 5 has a substantially circular shape with a central axis C of the tunable wavelength interference filter 1 at the center.

The second reflective film 6 is provided at the top surface of the first base 34 of the second substrate 3 so as to face the first reflective film 5 with the predetermined gap G1 therebetween in the Z direction. In addition, in plan view as viewed from the Z direction, the second reflective film 6 has a substantially circular shape with the central axis C of the tunable wavelength interference filter 1 at the center.

In addition, as the first reflective film 5 and the second reflective film 6, film members with reflective properties in a predetermined optical wavelength range are used. For example, as the first reflective film 5 and the second reflective film 6, dielectric multi layer films composed of alternately stacked Si and SiO₂ may be used.

The first conductive film 7 is provided at the first surface 21 of the first substrate 2. In addition, in plan view as viewed from the Z direction, the first conductive film 7 has a substantially ring shape around the central axis C of the tunable wavelength interference filter 1. More specifically, the first conductive film 7 is disposed overlapping a range from a peripheral part 51, which is the outer peripheral side edge of the first reflective film 5, to the diaphragm part 25 of the first substrate 2. In this first conductive film 7, the portion overlapping the peripheral part 51 of the first reflective film 5 in the Z direction forms a stopper film 71.

The first conductive film 7 is formed of an alloy film, such as an Au/Cr metal laminate, for example. In addition, the first conductive film 7 is coupled to the control circuit through electrode wires and the like (omitted in the drawing), and is set to ground potential.

The second conductive film 8 is provided at the third surface 31 of the second substrate 3. In addition, in plan view as viewed from the Z direction, the second conductive film 8 forms a stopper film 81, the capacitance detection electrode 82 and the drive electrode 83 in this order from the inside with the central axis C of the tunable wavelength interference filter 1 at the center. The stopper film 81, the capacitance detection electrode 82 and the drive electrode 83 are separated from each other by slits, and have respective substantially ring shapes around the central axis C of the tunable wavelength interference filter 1. Note that as with the first conductive film 7, the second conductive film 8 is formed of an alloy film, such as an Au/Cr metal laminate, for example.

The stopper film 81 may be disposed overlapping a peripheral part 61, which is the outer peripheral side edge of the second reflective film 6, in the Z direction so as to extend from the second reflective film 6 of the peripheral part 61 to the first base 34. In addition, the stopper film 81 faces the stopper film 71 in the Z direction. The size of a gap G2 between the stopper films 71 and 81 in the Z direction is smaller than that of the gap G1 between the first reflective film 5 and the second reflective film 6.

Note that in the embodiment, when the tunable wavelength interference filter 1 is viewed from the Z direction, the filter region R1 is the region disposed inside the stopper films 71 and 81 in the region where the first reflective film 5 and the second reflective film 6 overlap each other. The transmission wavelength of this filter region R1 corresponds to the size of the gap G1 between the first reflective film 5 and the second reflective film 6.

The capacitance detection electrode 82 is disposed at the second base 35 so as to face the first conductive film 7. The capacitance detection electrode 82 makes up a capacitance detection unit together with the first conductive film 7, and is coupled to the control circuit through electrode wires and the like (omitted in the drawing). Here, the control circuit includes a detection circuit that detects the capacitance between the capacitance detection electrode 82 and the first conductive film 7, and a high frequency voltage for detecting that capacitance is applied by the detection circuit to the capacitance detection electrode 82.

The drive electrode 83 is disposed at the bottom surface of the recess 33 of the second substrate 3 so as to face the first conductive film 7. The drive electrode 83 makes up an electrostatic actuator together with the first conductive film 7, and is coupled to the control circuit through electrode wires and the like (omitted in the drawing). Here, a drive voltage for driving the electrostatic actuator is applied by the control circuit to the drive electrode 83. At the electrostatic actuator, the electrostatic attraction between the drive electrode 83 and the first conductive film 7 is generated, and the gap G1 is changed when the movable part 24 of the first substrate 2 is displaced toward the second substrate 3 in the Z direction.

The stopper post 9 is provided at the second substrate 3. The stopper post 9 protrudes toward the first substrate 2 so as to be exposed from the second conductive film 8. In addition, the stopper post 9 includes an opposing surface 91 that faces the first conductive film 7 in the Z direction through a gap G3 therebetween. In plan view as viewed from the Z direction, at least a part of the stopper post 9 is disposed overlapping the diaphragm start region R2 of the first substrate 2.

Note that in the embodiment, a plurality of the stopper posts 9 is provided inside the region where the drive electrode 83 is disposed. The plurality of the stopper posts 9 is intermittently provided at even intervals on a virtual circle around the central axis C of the tunable wavelength interference filter 1.

The stopper post 9 of the embodiment is formed integrally with the second substrate 3 using the same material as the second substrate 3 (i.e., a transparent insulating material). For example, the stopper post 9 of the embodiment is formed together with the recess 33, the first base 34 and the second base 35 through etching on the preform (base material) of the second substrate 3.

Preferably, the size of the gap G3 between the stopper post 9 and the first conductive film 7 in the Z direction is smaller than that of a gap G4 between the drive electrode 83 and the first conductive film 7 in the Z direction, and greater than that of the gap G2 between the stopper films 71 and 81 in the Z direction. Note that it is assumed that the size of the gap G4 between the drive electrode 83 and the first conductive film 7 in the Z direction is greater than the size of the gap G1 between the first reflective film 5 and the second reflective film 6. Specifically, in the embodiment, the gaps G1 to G4 have a relationship of G2<G1, G2<G3<G4.

Note that the control circuit for controlling the tunable wavelength interference filter 1 according to the embodiment may have a known configuration. For example, the control circuit may detect the size of the gap G1 using the capacitance detection unit, and feedback-control the electrostatic actuator so as to set the gap G1 to a desired size. In this manner, the tunable wavelength interference filter 1 can transmit light of a desired wavelength.

### Operation of Tunable Wavelength Interference Filter 1

As described above, in the tunable wavelength interference filter 1 according to the embodiment, when a drive voltage is input to the drive electrode 83, the movable part 24 of the first substrate 2 is displaced toward the second substrate 3, and thus the gap G1 between the first reflective film 5 and the second reflective film 6 is adjusted. Here, if an excessive drive voltage larger than the normal control range is input to the drive electrode 83 due to unexpected causes such as initial voltages, the amount of displacement of the movable part 24 may possibly become larger than usual and the first substrate 2 may interfere with the second substrate 3. Details are described below.

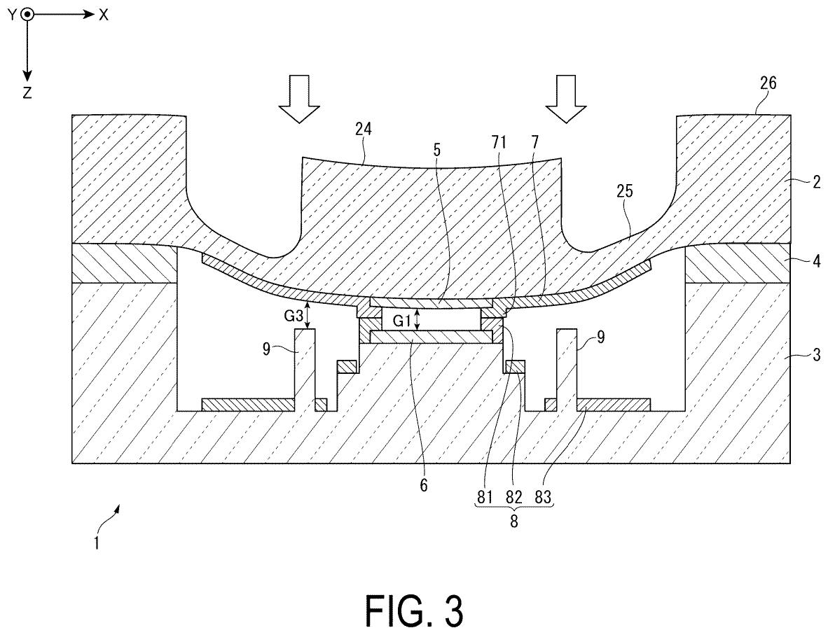

When an excessive drive voltage is input to the drive electrode 83, first, the movable part 24 of the first substrate 2 is displaced toward the second substrate 3, and the stopper films 71 and 81 make contact with each other. In other words, the stopper film 71 interferes with the second reflective film 6 through the stopper film 81, and the stopper film 81 interferes with the first reflective film 5 through the stopper film 71 (see FIG. 3). The timing when the stopper film 71 interferes with the second reflective film 6 (or the timing when the stopper film 81 interferes with the first reflective film 5) is referred to as first interference timing.

After the first interference timing, the stopper films 71 and 81 function as spacers between the first reflective film 5 and the second reflective film 6, thus restricting further displacement of the movable part 24 of the first substrate 2. In this manner, the gap G1 between the first reflective film 5 and the second reflective film 6 is maintained. Note that at the time point of the first interference timing, the gap G3 is present between the stopper post 9 and the first conductive film 7.

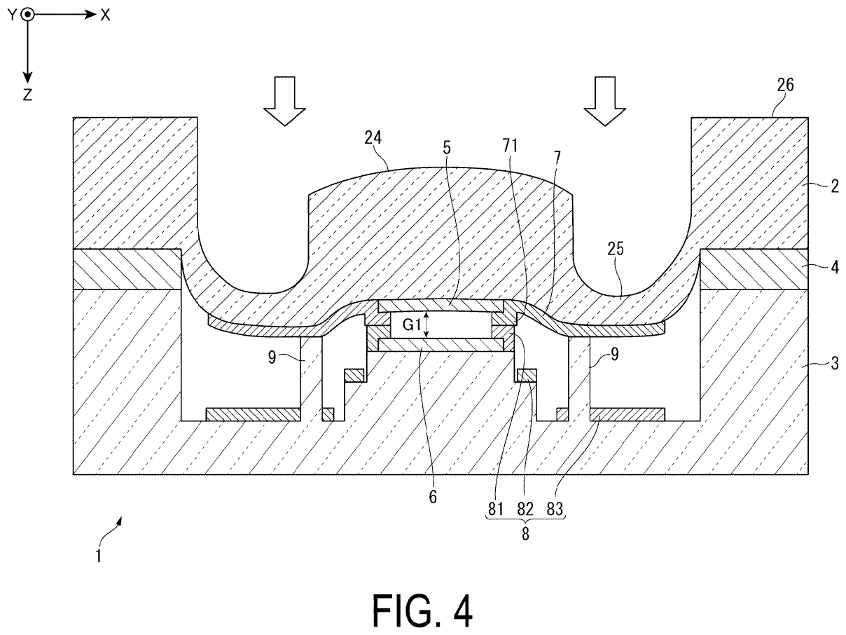

When the drive voltage is particularly large, the diaphragm part 25 of the first substrate 2 is further displaced toward the second substrate 3 even after the first interference timing. In this manner, the stopper post 9 interferes with the first conductive film 7 (see FIG. 4). The time point when the stopper post 9 interferes with the first conductive film 7 is referred to as second interference timing. After the second interference timing, the stopper post 9 functions as a spacer between the first conductive film 7 and the second conductive film 8, thus restricting further displacement of the diaphragm part 25 of the first substrate 2.

As described above, in the embodiment, the film thickness of the stopper film 81 and the height of the stopper post 9 (specifically, the above-described gaps G2 and G3) are adjusted such that the second interference timing of the interfere of the stopper post 9 is later than the first interference timing of the stopper film 81.

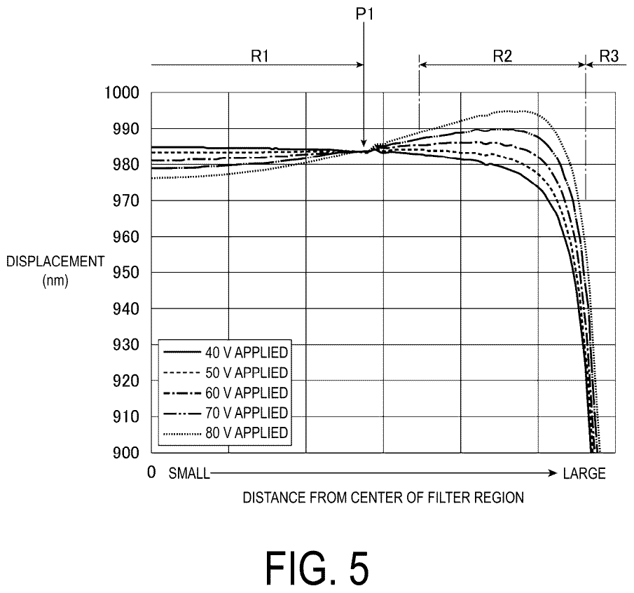

Now the amount of displacement in each portion of the first substrate 2 is described below with reference to FIG. 5. The graph of FIG. 5 illustrates the amount of displacement in each portion of the first substrate 2 corresponding to the distance from the center portion of the first reflective film 5. FIG. 5 illustrates simulation data of a case where the drive voltage is changed to an excessive drive voltage (40 V to 80 V) larger than a normal control range. In addition, FIG. 5 illustrates ranges of the filter region R1, the diaphragm start region R2, and a flat region R3.

Note that in the graph of FIG. 5, the stopper films 71 and 81 are in contact with each other at the drive voltages of 40 V to 80 V. In addition, the stopper post 9 is not in contact with the first conductive film 7 at the drive voltages of 40 V to 80 V, and the stopper post 9 makes contact with the first conductive film 7 at a drive voltage larger than 80 V.

As illustrated in FIG. 5, at the position of the stopper films 71 and 81 (a position P1 in FIG. 5), the amount of displacement is constant regardless of the change of drive voltage. In addition, in the flat region R3 corresponding to the flat part 251 of the first substrate 2, the amount of displacement decreases with increasing distance from the center portion the first reflective film 5, regardless of the change of drive voltage.

In addition, as illustrated in FIG. 5, in the filter region R1 inside the stopper films 71 and 81, the larger the drive voltage, the smaller the amount of displacement, whereas in the diaphragm start region R2 outside the stopper films 71 and 81, the larger the drive voltage, the larger the amount of displacement. In particular, at drive voltages of 70 V and 80 V, the amount of displacement in a part of the diaphragm start region R2 is larger than the amount of displacement in the filter region R1 or at the position P. This phenomenon is thought to be caused by the fact that when the drive voltage is larger than a predetermined value, the movable part 24 has a convex deflection toward the direction opposite to the Z direction (the direction from the second substrate 3 toward the first substrate 2) as illustrated in FIG. 4.

As described above, in the first substrate 2 of the embodiment, the amount of displacement in the diaphragm start region R2 may possibly become larger than in the stopper film 71. In view of this, the stopper post 9 of the embodiment is disposed overlapping the diaphragm start region R2 in plan view as viewed from the Z direction. In this manner, when a particularly large drive voltage is applied, the stopper post 9 can favorably prevent the interference with the first conductive film 7 and the second conductive film 8.

### Operation and Effect of Embodiment

(1) The tunable wavelength interference filter 1 according to the present disclosure includes the first substrate 2 including the movable part 24 and the diaphragm part 25 configured to displaceably support the movable part 24, the first reflective film 5 formed in the movable part 24 of the first substrate 2, the first conductive film 7 formed around the first reflective film 5 in the first substrate 2, the second substrate 3 facing the first substrate 2, the second reflective film 6 provided at the second substrate 3 and facing the first reflective film 5 with the predetermined gap G1 between the first reflective film 5 and the second reflective film 6, the second conductive film 8 provided at the second substrate 3 and facing the first conductive film 7, and the stopper post 9 provided as a part of the second substrate 3, and protruding toward the first substrate 2 so as to be exposed from the second conductive film 8. At least one of the first conductive film 7 and the second conductive film 8 includes the stopper film 81 disposed overlapping a peripheral part of the first reflective film 5 or a peripheral part of the second reflective film 6, and in a case where the movable part 24 is displaced toward the second substrate 3, the timing (the above-described second interference timing) when the stopper post 9 interferes with the first conductive film 7 is later than the timing (the above-described first interference timing) when the stopper film 81 interferes with the first reflective film 5 or the second reflective film 6.

In the embodiment, since the stopper film 81 functions as a spacer for the first reflective film 5, the interference of the first reflective film 5 and the second reflective film 6 can be prevented. This can prevent the phenomenon of sticking of the first reflective film 5 and the second reflective film 6, and the damage.

In addition, in the embodiment, since the stopper post 9 functions a spacer for the first conductive film 7, the interference of the first conductive film 7 and the second conductive film 8 can be prevented. This can prevent discharge breakdown.

In addition, in the embodiment, a part of the second conductive film 8 forms the stopper film 81. In this manner, the stopper film 81 can be formed using the deposition step for the second conductive film 8 making up the electrostatic actuator.

In addition, in the embodiment, a part of the second substrate 3 forms the stopper post 9. In this manner, the stopper post 9 can be formed using the etching step for processing the substrate preform (base material) for forming the second substrate 3.

Here, comparing the deposition step for forming the stopper film 81 and the etching step for forming the stopper post 9, the height accuracy of the etching step is lower than the height accuracy of the deposition step. That is, the height accuracy of the stopper post 9 is lower than the thickness accuracy of the stopper film 81. In view of this, the tunable wavelength interference filter 1 according to the embodiment is configured such that the second interference timing of the stopper post 9 is later than the first interference timing of the stopper film 81. In this manner, even if there is a manufacturing error in height of the stopper post 9, the situation where the stopper post 9 hinders the normal displacement of the movable part 24 can be avoided.

Thus, according to the embodiment, the manufacturing method for the tunable wavelength interference filter 1 can be simplified, and the function of the tunable wavelength interference filter 1 can be reliably ensured.

Note that as a tunable wavelength interference filter according to a comparative example, a case where the second interference timing of the stopper post 9 is earlier than the first interference timing of the stopper film 81 is described below. In this comparative example, even when a drive voltage within the normal control range is applied, the stopper post 9 may possibility interfere with the first conductive film 7 and hinder the displacement of the movable part 24 due to manufacturing errors in the height of the stopper post 9. As a result, in the tunable wavelength interference filter according to the comparative example, the range in which transmission wavelength can be changed is limited.

In contrast, in the tunable wavelength interference filter 1 according to the embodiment, the stopper post 9 does not hinder the normal displacement of the movable part 24, and thus the changeable wavelength range can be widely ensured.

(2) In the tunable wavelength interference filter 1 according to the embodiment, not only the second conductive film 8 includes the stopper film 81, but also the first conductive film 7 includes the stopper film 71. This stopper film 71 is disposed overlapping the peripheral part 51 of the first reflective film 5, and the timing when the stopper film 71 interferes with the second reflective film 6 is earlier than the second interference timing of the stopper post 9 as the first interference timing as with the timing when the stopper film 81 interferes with the second reflective film 6.

With this configuration, the interference of the first reflective film 5 and the second reflective film 6 can be more reliably prevented.

In addition, the first reflective film 5 is electrically coupled to the ground circuit through the first conductive film 7 including the stopper film 71. In this manner, even in the case where the first reflective film 5 is a film with high resistivity such as a dielectric multi layer film, the first reflective film 5 can reliably be dropped to ground potential.

(3) In the embodiment, preferably, the diaphragm part 25 includes the flat part 251 with a uniform thickness smaller than the movable part 24 in the displacement direction (the Z direction) of the movable part 24, and the stopper post 9 is disposed facing the diaphragm start region R2, which is the region between the flat part 251 and the movable part 24 in the first substrate 2.

With this configuration, when an excessive drive voltage is applied, a most deflected portion in the first substrate 2 can be supported by the stopper post 9. In this manner, the interference of the first conductive film 7 and the second conductive film 8 can be more reliably prevented.

(4) In the embodiment, the size of the gap G2 between the stopper films 71 and 81 in the Z direction is equal to or smaller than the size of the gap G3 between the stopper post 9 and the first conductive film 7. Specifically, in the displacement direction (the Z direction) of the movable part 24, the size of the gap between the stopper film 71 and the second reflective film 6 and the size of the gap between the stopper film 81 and the first reflective film 5 is equal to or smaller than the size of the gap G3 between the stopper post 9 and the first conductive film 7.

With this configuration, the relationship between the first interference timing of the stopper films 71 and 81 and the second interference timing of the stopper post 9 can be favorably adjusted.

(5) In the embodiment, at the timing when the stopper films 71 and 81 interfere with the first reflective film 5 or the second reflective film 6 (the above-described first interference timing), there is the gap G3 between the stopper post 9 and the first conductive film 7 in the displacement direction of the movable part 24 (the Z direction).

With this configuration, the relationship between the first interference timing of the stopper films 71 and 81 and the second interference timing of the stopper post 9 can be favorably adjusted.

(6) The second conductive film 8 according to the embodiment includes the stopper film 81, the capacitance detection electrode 82 and the drive electrode 83 separated from each other by slits.

In this configuration, the stopper film 81 are electrically separated from each of the capacitance detection electrode 82 and the drive electrode 83. In this manner, it is not necessary to separately form an insulating layer on the stopper film 81. Thus, the manufacturing method for the tunable wavelength interference filter 1 can be further simplified.

### Modifications

The present disclosure is not limited to the embodiments described above, and modifications, improvements, and the like within the scope in which the object of the present disclosure can be achieved are included in the present disclosure.

In the above-mentioned embodiment, the stopper films 71 and 81 are disposed facing each other, but the present disclosure is not limited to this. For example, in plan view in the Z direction, the first reflective film 5 and the second reflective film 6 may have sizes different from each other, and the positions of the stopper films 71 and 81 may be shifted from each other. In this case, the stopper films 71 and 81 may directly interfere with the first reflective film 5 or the second reflective film 6.

In the above-mentioned embodiment, the stopper film 71 is stacked at the top surface of the first reflective film 5, and the stopper film 81 is stacked at the top surface of the second reflective film 6, but the present disclosure is not limited to this. For example, the stopper film 71 may be stacked at the bottom surface of the first reflective film 5 (specifically, between the first reflective film 5 and the first substrate 2). Likewise, the stopper film 81 may be stacked at the bottom surface of the second reflective film 6 (specifically, between the second reflective film 6 and the second substrate 3).

In the above-mentioned embodiment, the first conductive film 7 includes the stopper film 71, and the second conductive film 8 includes the stopper film 81, but the present disclosure is not limited to this. For example, it is possible to adopt a configuration in which one of the first conductive film 7 and the second conductive film 8 includes the stopper film 71 (or the stopper film 81), and the other does not include the stopper film 81 (or the stopper film 71).

In the above-mentioned embodiment, the size of the gap G2 between the stopper films 71 and 81 is equal to or smaller than the size of the gap G3 between the stopper post 9 and the first conductive film 7 (specifically, the size of the gap between the stopper film 71 and the second reflective film 6 and the size of the gap between the stopper film 81 and the first reflective film 5 are equal to or smaller than the gap G3), but the present disclosure is not limited to this.

For example, in the case where the amount of displacement of the diaphragm part 25 is larger than the amount of displacement of the movable part 24 at the time point of the first interference timing of the stopper films 71 and 81, the above-described relationship of the gaps may be opposite.

In the above-mentioned embodiment, the stopper film 71 is formed in an annular shape along the peripheral part 51 of the first reflective film 5, and the stopper film 81 is formed in an annular shape along the peripheral part 51 of the second reflective film 6, but the present disclosure is not limited to this. For example, the stopper film 71 may be intermittently formed on the peripheral part 51 of the first reflective film 5, and the stopper film 81 may be intermittently formed on the peripheral part 51 of the second reflective film 6.

In the above-mentioned embodiment, the groove 23 of the first substrate 2 has an R-shape, and accordingly the diaphragm start region R2, which is the region between the flat part 251 and the movable part 24, has some width, but the present disclosure is not limited to this. For example, in the case where the groove 23 of the first substrate 2 does not have an R-shape, the boundary region between the flat part 251 and the movable part 24 may be set as the diaphragm start region R2.

### Overview of The Present Disclosure

(1) A tunable wavelength interference filter according to an aspect of the present disclosure includes a first substrate including a movable part and a diaphragm part configured to displaceably support the movable part, a first reflective film formed in the movable part of the first substrate, a first conductive film formed around the first reflective film in the first substrate, a second substrate facing the first substrate, a second reflective film provided at the second substrate and facing the first reflective film with a predetermined gap between the first reflective film and the second reflective film, a second conductive film provided at the second substrate and facing the first conductive film, and a stopper post provided as a part of the second substrate, and protruding toward the first substrate so as to be exposed from the second conductive film. At least one of the first conductive film and the second conductive film includes a stopper film disposed overlapping a peripheral part of the first reflective film or a peripheral part of the second reflective film, and in a case where the movable part is displaced toward the second substrate, a timing when the stopper post interferes with the first conductive film is later than a timing when the stopper film interferes with the first reflective film or the second reflective film.

(2) In the tunable wavelength interference filter according to an aspect of the present disclosure, the diaphragm part includes a flat part having a uniform thickness smaller than the movable part in a displacement direction of the movable part, and the stopper post is disposed facing a diaphragm start region, the diaphragm start region being a region between the movable part and the flat part in the first substrate.

(3) In the tunable wavelength interference filter according to an aspect of the present disclosure, in a displacement direction of the movable part, a size of a gap between the stopper film and the first reflective film or the second reflective film is equal to or smaller than a size of a gap between the stopper post and the first conductive film.

(4) In the tunable wavelength interference filter according to an aspect of the present disclosure, at a timing when the stopper film interferes with the first reflective film or the second reflective film, a gap is present between the stopper post and the first conductive film in a displacement direction of the movable part.

What is claimed is:

1. A tunable wavelength interference filter comprising:
a first substrate including a movable part and a diaphragm part configured to displaceably support the movable part;
a first reflective film formed in the movable part of the first substrate;
a first conductive film formed around the first reflective film in the first substrate;
a second substrate facing the first substrate;
a second reflective film provided at the second substrate and facing the first reflective film with a predetermined gap between the first reflective film and the second reflective film;
a second conductive film provided at the second substrate and facing the first conductive film; and
a stopper post provided as a part of the second substrate, and protruding toward the first substrate so as to be exposed from the second conductive film, wherein
at least one of the first conductive film and the second conductive film includes a stopper film disposed overlapping a peripheral part of the first reflective film or a peripheral part of the second reflective film, and
in a case where the movable part is displaced toward the second substrate, a timing when the stopper post interferes with the first conductive film is later than a timing when the stopper film interferes with the first reflective film or the second reflective film.

2. The tunable wavelength interference filter according to claim 1, wherein
the diaphragm part includes a flat part having a uniform thickness smaller than the movable part in a displacement direction of the movable part, and
the stopper post is disposed facing a diaphragm start region, the diaphragm start region being a region between the movable part and the flat part in the first substrate.

3. The tunable wavelength interference filter according to claim 1, wherein in a displacement direction of the movable part, a size of a gap between the stopper film and the first reflective film or the second reflective film is equal to or smaller than a size of a gap between the stopper post and the first conductive film.

4. The tunable wavelength interference filter according to claim 1, wherein at a timing when the stopper film interferes with the first reflective film or the second reflective film, a gap is present between the stopper post and the first conductive film in a displacement direction of the movable part.
